(19) United States
(12) Patent Application Publication
(10) Pub. No.: US 2015/0235576 A1
(43) Pub. Date: Aug. 20, 2015

(54) TAGGING SYSTEMS

(71) Applicant: SAY IT PERSONALLY LIMITED, Melton, Yorkshire (GB)

(72) Inventor: David Malcolm Goodwin, Pyrford (GB)

(73) Assignee: SAY IT PERSONALLY LIMITED, Melton (GB)

(21) Appl. No.: 14/429,270

(22) PCT Filed: Sep. 20, 2013
(86) PCT No.: PCT/GB2013/052477

§ 371 Date: Mar. 18, 2015

(30) Foreign Application Priority Data
Sep. 20, 2012 (GB) 1216835.7

(51) Int. Cl. G09F 3/00; G09F 3/08

(52) U.S. Cl. CPC G09F 3/0288; G09F 3/0286; G09F 3/08; G09F 2003/0282

(57) ABSTRACT

Two-part tags for attachment to a sheet form material (17), for example the cloth of a garment, are described. Each tag consists of a first part (1) adapted to carry a legend and having a substantially flat surface to lie against the sheet form material when the tag is used, and a perpendicularly projecting member projecting from the flat surface, and a second part (2) having a flat surface adapted to lie against the other side of the sheet form material when the tag is used, the second part including a receiving hole adapted to receive and hold the projecting member on the first part. The projecting member is a rod with a cone (4) on its end remote from the flat surface of the first part, the broadest part of the cone being of greater diameter than the remainder of the rod. The hole in the second part has a first section of diameter less than that of the wider end of the cone and a second section of diameter at least equal to that of the wider edge of the cone. The portion of the receiving hole in the second part adjacent the flat surface is elastically deformable to allow the passage of the cone, which may have a pointed end to pierce the material when the two parts are assembled, or a blunt end so that the rod which carries a deformed part of the sheet (17) through the hole. Tag application pliers are also described.

This invention relates to tagging systems, i.e. to methods of tagging articles so that they can be identified by one identifying marking on the tag or by means incorporating data within the tag, and for tags for use in such systems.

In situations where articles from different owners or users can become mixed up or mislaid, it is important that these articles can be returned to their correct owner or location. Such situations may include: laundries in hospitals and care homes that wash articles from several sources all together or schools where children often mislay articles of clothing or luggage. Tagging systems are helpful in identifying individual items, e.g. clothing, footwear, bedding or luggage. Such articles are typically made from, or include parts which are made from, flexible and semi-flexible materials, such as woven and knitted fabrics and cloth, leather and synthetic leather-type materials, and plastics films and foils.

The prior art provides many examples of tagging systems. These include simple sewn-on fabric labels that can be embroidered or otherwise marked e.g. with a person's name. Tagging systems are known where the tag stores information in the form of a barcode that can, when read, provide more information than merely an owner's name, for example a telephone number and address of the owner, or even washing instructions. A scanner is used to read the barcode and the information is shown on a display. Tags are known which include passive radio frequency identification transponders that can be programmed with information, see WO2012/080498, U.S. Pat. No. 8,115,639. The information is read when the tag is scanned by a remote reader which can be a hand-held device. A disadvantage of such systems is the cost of the tag and associated equipment. Many simple tag constructions are known which are a tag formed of one or more pieces of plastic or another durable material that can be attached by various means, and where the piece of durable material has e.g. the owner's information, such as their name, engraved, printed or otherwise marked on the tag so that the information can be easily read.

The method of attaching a tag to an item is of particular importance if many articles need to be tagged rapidly. For example, in a care home situation, all of a new resident's clothes need to be tagged when they move into the home, either by the care home staff or by the new resident's family. In other cases, the tags need to be capable of attachment quickly and without needing special training, but also in a way which ensures total security of the attachment. Sew-on labels require a level of skill and are also time consuming and may require a sewing machine or similar equipment. It is important that the tag is securely fixed to the article so that it does not become detached during washing cycles or be removed without authorisation. Many tagging systems are known where the tag can be removed only by using a dedicated tool, or by physically breaking the tag.

While tags consisting of a piece of durable material may be riveted, screwed, clamped or otherwise attached to an article, a particularly preferred general form of tag is a two parts tag consisting of a front part that usually contains or carries the information and a back part that acts to fix the front part against a surface of the article. For example, the front part may be screwed to the back or receiving part by means of a screw integral with one or other part or a separate screw. The screw will pass through the material and, for example, may be configured to pierce the material when the two parts are joined together. The time taken to attach the tag can be kept short, while nevertheless ensuring that the tag is securely attached, by configuring the two parts so that they may be positioned either side of a sheet-form material forming part of the of article to be tagged and then be engaged with one another by moving them together, such movement enabling one of the tag parts to pierce a hole in the article and then lock in the part of the tag, this being achieved by a single movement.

The way in which the sheet-form part of the article is pierced may need to vary as the sheet-form part in question can be made from a very wide range of materials and thicknesses and their material properties may be very different. For example, some materials may stretch more than others which will affect the way the material behaves when the tag parts pierce the material and be much more difficult to pierce than a material that does not stretch. However, if the material is sufficiently stretchy or deformable, tagging may occur using a tag where a projection on one part is adapted to push a small section of the material into the other part with the two parts then locking together to trap the material between them.

According to a first feature of the present invention, there is provided a two-part tag for attachment to a sheet form material, the tag consisting of a first part adapted to carry a legend and having a substantially flat surface to lie against the sheet form material when the tag is used, and a perpendicularly projecting member projecting from the flat surface, and a second part having a flat surface adapted to lie against the other side of the sheet form material when the tag is used, the second part including a receiving hole adapted to receive and hold the projecting member on the first part, and wherein the projecting member is a rod with a cone on its end remote from the flat surface of the first part, the broadest part of the cone being of greater diameter than the remainder of the rod, and wherein the hole in the second part has a first section of diameter less than that of the wider end of the cone and a second section of diameter at least equal to that of the wider edge of the cone, and wherein the portion of the receiving hole in the second part adjacent the flat surface is elastically deformable to allow the passage of the cone.

The proposed tag thus consists of two parts, a first or front part that sits on one side of the material to be tagged and a second or receiving part which lies against the other side, aligned with the front part. The front part may have a flat planar form such as a flat disc which can be marked on the face side with an owner's name or other information by a variety of means including engraving, printing, laser etching, etc. The reverse side of the front part has a perpendicular projecting rod or stem. The length of the stem, i.e. the amount it projects from the back surface of the tag front part, is designed to be sufficiently long to pass through the article and then into the receiving part, or to distort a part of the article so that it lies held in the second part by the cone about which the distorted part of the sheet-form article is stretched.

When the tag front part and receiver are aligned and pressed together, the stem will first pierce or distort the material and then pass into the receiving hole in the receiver. This will occur in a single operation. In the first case if the stem consists of a rod which has a pointed cone at its distal end, the point of the cone may pierce the material, after which the remainder of the stem passes through the hole in the material which the cone has made. The diameter of the base of the cone is larger than the diameter of the stem to create a step behind the cone which acts as a latching area for the mating part of the receiver. Where the stem joins the reverse surface of the tag, the stem can be shaped to reinforce the junction by a fillet radius or chamfer.

In the second case, if the cone has a blunt narrower end, a distorted piece of the material comes to lie closely about the cone and the stem, but the cone is still held firmly in the receiver since the wider end of the cone has passed through the hole and the resilient edge of the hole has sprung back to trap the con and surrounding material.

If the front part of the tag has to be able to pierce a range of materials with varying properties, it should be pointed. In such cases a material with a higher degree of stretch, such as a fabric with elastic qualities, for example a sweat shirt, will be more difficult to pierce than a material with limited stretch such as a cotton shirt or sheet. The reason is that the material with more stretch will deform as the piercing cone is forced against it, before the cone actually pierces the material. When applying a tag, it may be desirable to clamp the material around the piercing area to limit the amount of stretch which the material can undergo before piercing occurs.

In systems where the piercing of the material is desire, these should be designed to ensure that the material should have been properly pierced so that the rod or stem can pass through the material and engage with the receiver without the material interfering with the engagement of the mating parts of the tag. If the material is not fully pierced, there is a danger that some of the material will be pulled into the engagement area and prevent the tag parts from engaging properly, which will compromise the security of the attachment allowing the tag to be removed too easily or perhaps falling off the article over time. In such piercing systems, the design of the receiver plays a critical role in the efficiency of the piercing of the material which occurs when the pointed end of the cone is pressed into the material and starts to create a hole which will progressively get larger as the cone is forced through the fabric. The critical part of the operation is to ensure that the cone point can create the initial opening.

When the cone point first engages the material, the material is first forced against the receiver and the cone and receiver effectively form a punch and die, with the cone forming the punch and the receiver the die. When the stem is fully inserted into the receiver, part of the receiver engages or latches behind the cone therefore preventing the two parts from being separated easily. The receiver has a hole in the surface through which the stem passes that is smaller than the diameter of the base of the cone, the first hole, on the distal end of the stem. The hole thus usually includes a section in the shape of a counter bore extending from the surface of the second part which lies away from the surface of the article being tagged to provide a clearance hole for the cone base. Thus a step is created where the first hole and second hole meet that engages behind the base of the cone when the cone is forced through the first hole. The first hole is able to enlarge as the cone is forced through and return to its original form after the base of the cone has passed beyond the step into the second hole.

The design of the first hole and the shape of the cone are both critical factors in the piercing efficacy of the system. The receiver's first hole must be sized and shaped to support the material to be pierced as much as possible to prevent it from being stretched too much whilst, at the same time, allow the hole to expand sufficiently for the cone to pass through and then return to its original size. If the first section of the hole in the second part adjacent has a membrane bridging the hole, this can provide a solid surface which assists in preventing the material from being pushed into or dragged down into the hole. The cone point can be pushed into the material whilst the material is supported by the membrane which will prevent it from being stretched towards the second hole. Once the cone point has pierced the material it can then penetrate the membrane to allow the rest of the cone to pass through.

Another approach is to size the first part of the hole sufficiently small to stop material from being dragged into the hole by the cone. When the pressure is applied to the cone point, it will first press the material into the edge of the hole which will then become trapped between the edge and the cone. As more pressure is applied, the cone point will then pierce the material, which is under tension, before passing through the hole and into the second hole.

For cases where the material is thin, but sufficiently flexible to be pushed by the projecting member into the hole in the second part of the tag, the cone may be relatively blunt.

In either case, as the cone is pressed into the hole in the second part of the tag, the periphery of the hole can deform to allow the compete cone to pass through and then return to its original form to engage behind the base of the cone. This can be achieved in a number of ways. The first method is to manufacture the receiver in a material and shape whereby the plastic limit of the material surrounding the hole is not exceeded and the hole is not therefore permanently deformed. Careful selection of the material, such as a nylon polymer in conjunction with the hole shape will achieve the objective. The wall that creates the step should be sufficiently wide and shaped to provide more flexibility in certain areas. For example, the wall immediately surrounding the hole could be thinner than the rest of the wall. This will allow that part of the wall to deform downwards more easily to allow the cone body to pass through the enlarged hole. Once the cone has passed through, the thinner wall, which has not been deformed past its elastic limit, will want to return to the original form. The original hole size is less than the stem diameter and the wall will return until the edge of the hole sits against the stem or against the material trapped between the stem and the edge of the hole. The wall will be angled towards the base of the cone and it will therefore be more difficult to pull the cone back through the hole to separate the two tag parts as the wall will have to fold back on itself.

The parts of the tags may be mounted in a carrier, e.g. a strip of material, by way of a groove about their edges which receives the edges of an aperture in the carrier, which may be, for example, of paper, foil or a plastics film.

Another feature of the system is the method of assembling the tag to the article. It is proposed to use a tool that will correctly align the tag and the receiver so that the cone will enter the receiver in the correct position. Failure to do so can result in damage to the tag stem as the cone will miss its critical entry point and be pressed against part of the receiver which will not accept the cone and the stem will be deformed or broken.

The present invention also provides apparatus for applying two-part tags as described above, the apparatus comprising a pair of pliers wherein each of the two facing jaws of the pliers has a track formed in the surface thereof, and each track has a recess corresponding to the shape and size of one of the two parts of the two-part tag whereby the two parts of the two-part tag may be mounted in a strip of material sized to fit the track so that when the two parts are located by means of the strip of material fitted to the track and registered with the recesses, the two parts may be pressed together by closing the jaws of the pliers together around a sheet form material to which the tag is to be attached, with penetration of the rod on one part into the receiving hole in the other, whereafter the tag parts are pulled away from the strips of material. In such apparatus, the jaws of the pliers incorporate features to retain the tag and receiver so when the jaws are closed together, the tag portions are assembled together with the rod passing through the material of the object being tagged or being covered by a portion of the material which is trapped by the interengagement of the two parts of the tag.

To assist the tagging of lots of articles in one tagging exercise, the tags may be set in strips, each stored in a magazine arranged so that the ends of each strip can be fed through the jaws until each part automatically aligns itself in the correct position in the jaws by registering with the recess in the jaw. Each magazine may contain a flat strip of material, such as a polypropylene thin sheet, card or paper that has an array of regularly spaced holes arranged down the length of the strip, into which one or other tag part is set via a groove around its circumference. The width of the groove is slightly wider than the thickness of the magazine strip. The receiver or tag can be press-fitted into these holes so that the strip engages with the groove and holds the tag or receiver in place. The jaws may each have a track way to enable the strip to be fed through the jaw, keeping the receiver or tag correctly aligned in the track way plane in either jaw. Each jaw has an indent or recess that corresponds to the correct location in the other plane in the jaw so that when the magazine strip is pulled through the jaws, the receiver or tag will drop into the indent when it reaches the correct position. Once the tag parts are assembled onto the article, the jaws can be opened by moving the handles of the pliers apart and the two parts pulled out of engagement from the strips. The strips may remain trapped in their track ways and can then be pulled through until the next tag parts locate in their respective indents in the jaws. Such an arrangement avoids having to load the two parts of each tag separately, enabling the time taken to tag a set of articles to be much reduced. The magazine strips can be supplied in short lengths or in rolls.

The invention is is illustrated by way of example with reference to the accompanying drawings in which:

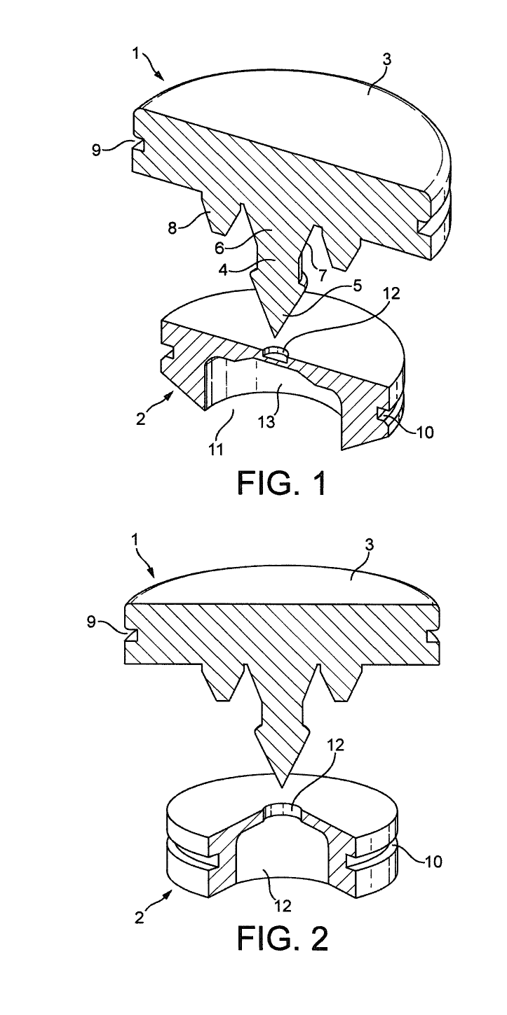

FIG. 1 is an exploded view of a two-part tag according to the invention, part cut away to show its construction more clearly;

FIG. 2 is a similar view of an alternative construction;

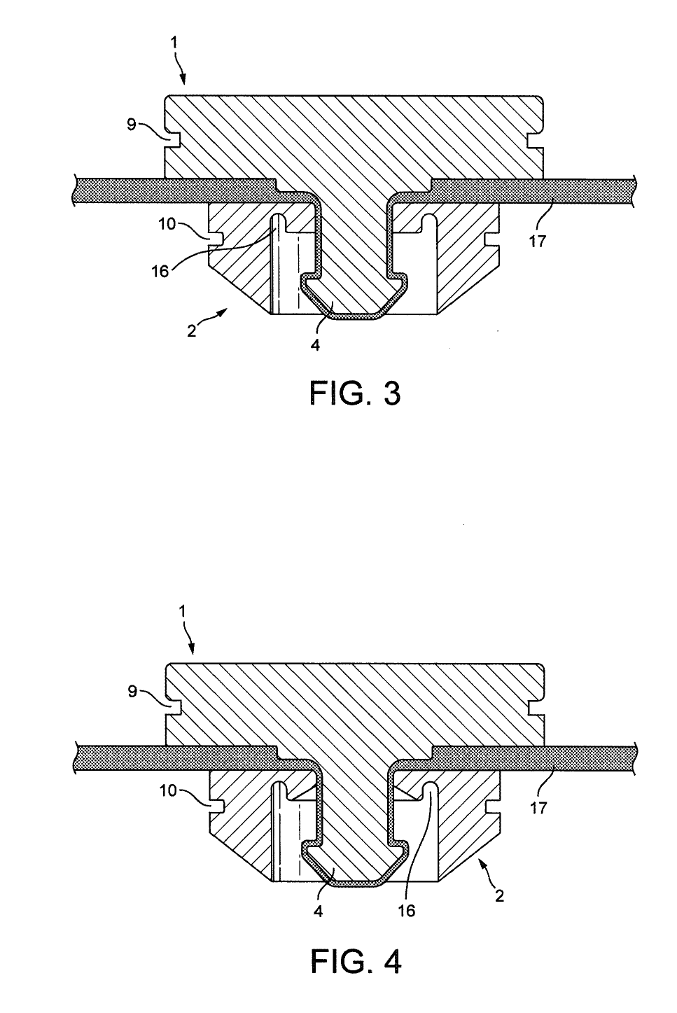

FIG. 3 is a diagrammatic sectional view of a tag according to the invention assembled about a piece of fabric;

FIG. 4 is a view similar to FIG. 3 where the shape of the lower part differs;

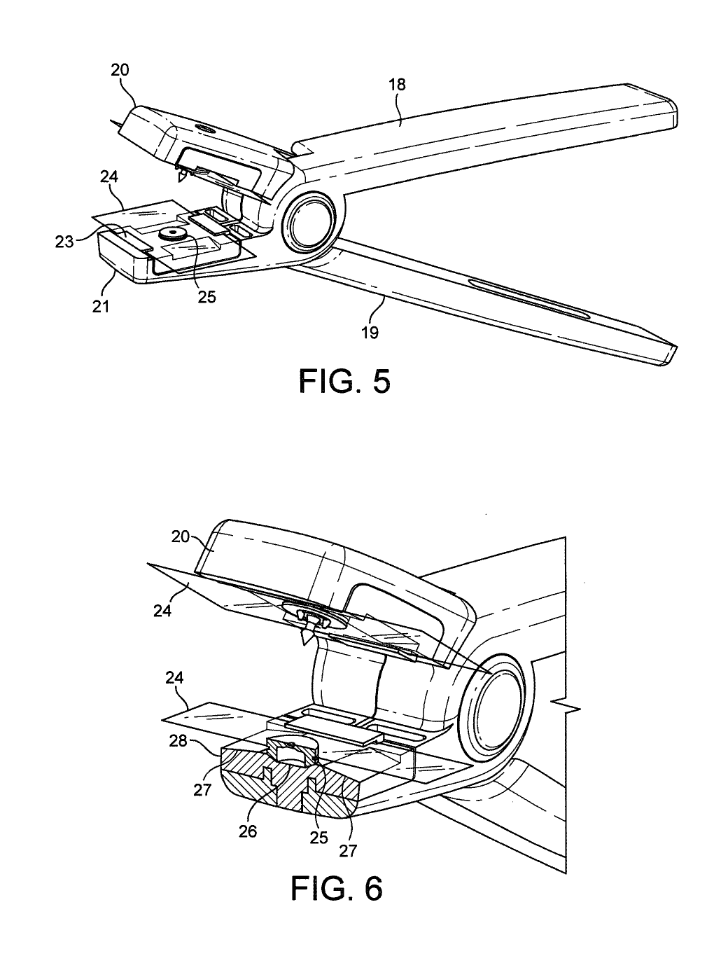

FIG. 5 is a perspective diagram of a set of tag-applying pliers in accordance with the invention, and

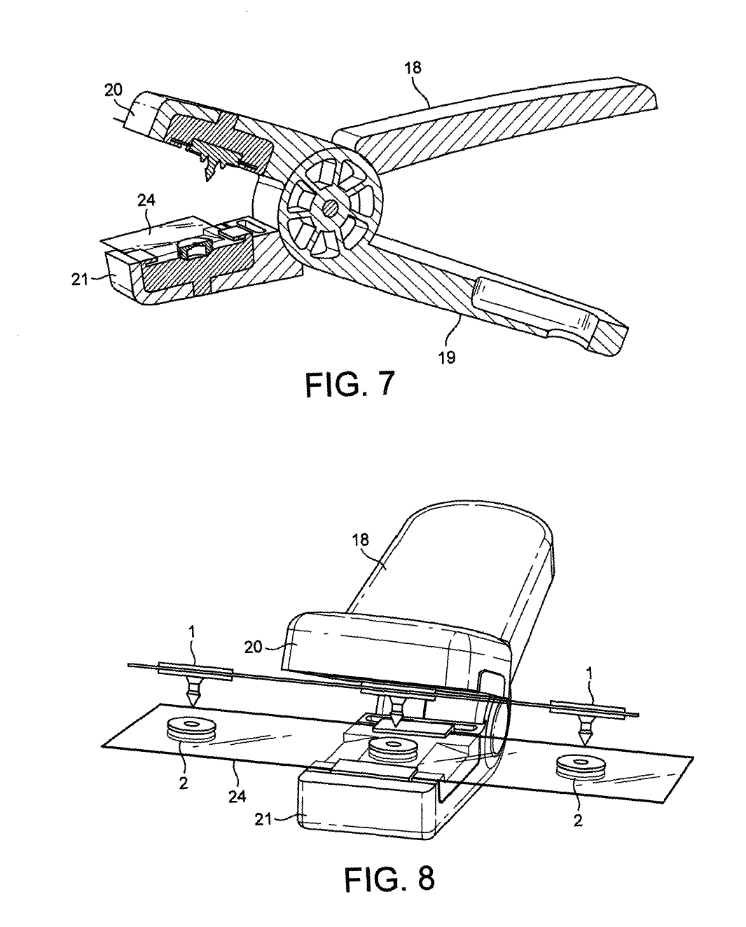

FIGS. 6 and 8 are views of the open jaws of the pliers shown in FIG. 5 from three different angles and, in FIGS. 6 and 7, part cut away.

Referring to FIG. 1, this shows a vertical cutaway section through an unassembled tag formed of a first part 1 and a second part 2. Each is circular in plan view. The upper surface 3 of part 1 may be marked with a legend to provide information, for example using a suitable marker or e.g. by laser etching to provide a permanent relief marking. A stem 4 projects perpendicularly from the base of part 1. The stem 4 has a conical end 5 that is designed to pierce the material of an article to be tagged. Where the stem 4 joins the underside of part 1 of the tag at 6, the stem has a chamfered fillet 7 for reinforcement. The underside of the tag part 1 has one or more projections 8 that act as depth stops when the parts of the tag are assembled to prevent the point of the conical end 5 from protruding out of the base of the second part 2. Part 1 has a peripheral groove 9 to enable it to be retained in a perforated strip with holes of corresponding shape in it and of thickness slightly less than the width of the groove.

Part 2 has a counter bore hole 11 on the underside and a small hole 12 on the upper side through which the stem passes. The hole 12 has a membrane 13 across it to provide a support surface for the material to facilitate penetration and to avoid the material from being pushed down and through hole 12 when the item is tagged. Part 2 has a peripheral groove 10 to enable it to be retained in a magazine strip 24.

FIG. 2 shows an alternative form of the tag where the hole 12 does not have a membrane 13 across it.

FIG. 3 shows an alternative construction where the section of the part 2 surrounding hole 12 is in the form of an annular ring. A moulded groove 16 enables the ring to flex as the head of the stem is pushed through hole 12. Flexing may be eased by chamfering the ring, as shown in FIG. 4.

FIGS. 3 and 4 show the tag in cross-section and assembled to an article, part of which is a fabric sheet 17. The parts of part 2 surrounding the hole 12 through which the conical end of the stem has passed, flex downwards to allow the cone to pass through and then partly recover their original position until they engage with the stem and thus lock parts 1 and 2 of the tag together. In this embodiment, the narrower end of the cone is blunt and the fabric sheet 17 is stretched round itas the two parts are assembled together and then trapped between the two parts when the cone 4 passes through the hole 12.

FIGS. 5 to 8 show a pliers type tool used to fix the tag to an article. The jaws are shown in an open position. The tool consists of two opposing legs 18 and 19 which are pivoted together. The legs have opposing jaws 20 and 21 and each jaw has a track way 23 into which a magazine strip 24 can be fed. The two parts of the tags are located in a series of holes 25 that are punched in the strip 24.

FIG. 6 shows a cutaway section across the lower jaws 25. When the strips are pulled through the jaws, the part 1 and 2 of each tag drop into their recesses 26 in the jaws to ensure that they are aligned and positioned correctly. The sides of the jaws have an inclined plane 27 to each side of the recess 26, so as to guide the tag and receiver up to their respective recess. Without the incline, each part would be unable to pass beyond the side face of the jaws 28 as the side of each part that projects out of the strip 24 and is intended to drop into the recess 26 would stop against the jaws.

FIG. 7 shows a longitudinal cutaway section through the tool.

FIG. 8 shows the pliers and the strips fitted with multiple tag parts. In practice, the tag parts to one side of the jaws will have been fitted together to the projecting strips it will simply have the holes 25 in them where parts 1 and 2 of each tag were previously located.

Not shown in FIGS. 5 to 8 of the drawings is a tag removal tool formed in one of the handles 18,19. The tool is in the form of an elongate oval slot of width slightly greater than the width of the tag portion 1. At one end of the slot, it goes all the way through the material of the handle. On the edges of the slot, extending towards its other end, are two wedge-shaped portions with a space between them, with one side of the wedges flush with the surface of the handle, so that viewed from that side the slot has the appearance of a keyhole. By locating the round part of the keyhole shape over the tag part 1, with the die of the handle lying against the material, and moving the handle along, the wedge-shaped parts move in between part 1 and the material of the tagged item and as they do so the part 1 is pulled out from part 2. Once the cone 4 has passed through aperture 12, the two parts of the tag are no longer held together and fall away from the material.

1. A two-part tag for attachment to a sheet form material, the tag consisting of a first part adapted to carry a legend and having a substantially flat surface to lie against the sheet form material when the tag is used, and a perpendicularly projecting member projecting from the flat surface, and a second part having a flat surface adapted to lie against the other side of the sheet form material when the tag is used, the second part including a receiving hole adapted to receive and hold the projecting member on the first part, and wherein the projecting member is a rod with a cone on its end remote from the flat surface of the first part, the broadest part of the cone being of greater diameter than the remainder of the rod, and wherein the hole in the second part has a first section of diameter less than that of the wider end of the cone and a second section of diameter at least equal to that of the wider edge of the cone, and wherein the portion of the receiving hole in the second part adjacent the flat surface is elastically deformable to allow the passage of the cone.

2. A tag according to claim 1 wherein the first section of the hole in the second part adjacent the flat surface thereof does not extend to the surface of the second part to provide a frangible support surface which is broken when the projecting member on the first part is inserted into the hole in the second part.

3. A tag according to claim 1 wherein the periphery of the receiving hole in the second part adjacent the flat surface thereof is formed as an annular plate attached to the remainder of the second part via a ring of material of axial extent less than the thickness of the plate.

4. A tag according to claim 1 wherein the first and second parts of the two-part tag each have a peripheral groove lying in a plane perpendicular to the axis of the rod and extending around the exterior of each part.

5. A tag assembly consisting of a plurality of tag portions, each being a part of a two-part tag as set out in claim 4 and each being set in a carrier member having one or more apertures in it of shape and size matching the shape and size of the groove in the respective tag part.

6. An assembly according to claim 5 wherein each tag part is one of a plurality of such parts and the carrier member is a strip with a plurality of such apertures evenly spaced along it.

7. Apparatus for applying two-part tags in accordance with claim 1, in combination with a pair of pliers wherein each of the two facing jaws of the pliers has a track formed in the surface thereof, and each track has a recess corresponding to the shape and size of one of the two parts of the two-part tag whereby the two parts of the two-part tag may be mounted in a strip of material sized to fit the track so that when the two parts are located by means of the strip of material fitted to the track and registered with the recesses, the two parts may be pressed together by closing the jaws of the pliers together around a sheet form material to which the tag is to be attached, with penetration of the rod on one part into the receiving hole in the other, whereafter the tag parts are pulled away from the strip of material.

8. Apparatus according to claim 7 wherein a handle of the pliers contains a pair of spaced wedges either side of a slot to enable the apparatus to act as a tag removal tool.
